(19) United States
(12) Patent Application Publication
(10) Pub. No.: US 2006/0155944 A1
(43) Pub. Date: Jul. 13, 2006

(54) System and method for data migration and shredding

(75) Inventor: Yoshiki Kano, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/036,427

(22) Filed: Jan. 13, 2005

(51) Int. Cl. G06F 12/16

(52) U.S. Cl. 711/161

(57) ABSTRACT

Migration techniques are described for moving data within a storage system from a source to a target location. After movement of the data from the source, the data is shredded by being overwritten with a predetermined pattern and the source location is designated as being made available for future data actions. In some implementations the shredding operation is only performed when the addressable locations are released from membership in a reserved group.

### BACKGROUND OF THE INVENTION

This invention relates to storage systems, and in particular to techniques of migrating data from one location to another in such systems.

Large organizations throughout the world now are involved in millions of transactions which include enormous amounts of text, video, graphical and audio information Which is categorized, stored, accessed and transferred every day. The volume of such information continues to grow. One technique for managing such massive amounts of information is the use of storage systems. Conventional storage systems can include large numbers of disk drives operating under various control mechanisms to record, mirror, remotely back up, and reproduce this data. This rapidly growing amount of data requires most companies to manage the data carefully with their information technology systems.

One common occurrence in management of such data is the need to move data from one location to another. The system is frequently making copies of data as protection in case of failure of the storage system. Copies of the data are sometimes made within the storage system itself, in an operation conventionally referred to as “mirroring.” This can provide reliability in case of component failures. Copies of the data are also frequently made and stored in remote locations by using remote copy operations. The storage of this data in a remote location provides protection of the data in the event of failures in the primary storage system, or natural disasters occurring in the location of the primary storage system. In such circumstances, the data from the remote copy operation can be retrieved from the secondary storage system and replicated for use by the organization, thereby preventing data loss.

Other reasons for migrating data from one location to another are a desire by the customer to move data from a high speed system to a lower speed system or vice versa. The higher speed systems, for example, Fibre Channel enabled disc arrays, generally are used for data access most frequently, while the lower speed systems, for example, Serial ATA or Parallel ATA enabled disc arrays, which cost less to acquire and operate, are often used to store data used less frequently, such as backup data or archival data. Another reason for moving data from one location to another is changes in the capacity of the system. A user may outgrow the storage system employed in its facility, and the purchase of additional capacity will involve moving data from locations on the older portion of the system to the newer system, or newer portion of the system. Typical prior art techniques, for example as described in IBM TotalStorage SAN volume controller or the FalconStor IPStore have volume migration capabilities.

Generally, current data migration technology typically copies data to the new location within the storage system and leaves a copy of the data at the old location. The copy at the old location may be designated, also using known technology, as data not to be used further, for example by a suitable indication in a table or index. Generally, however, the data itself remains unchanged at the old location. Because the data being migrated often includes confidential business information, or personally private information, for example, credit card numbers or medical information, it would be desirable to have the data from the source location deleted, overwritten, or otherwise rendered non-recoverable at the time it is copied or migrated to the target location. The prior art systems, however, do not provide for such actions to the source data after it has been copied to the target location.

### BRIEF SUMMARY OF THE INVENTION

This invention addresses issues involving data migration and the management of data in old storage after the migration. Preferably, after the data is migrated to a new location in the storage system, the old data is shredded. In one implementation the data is migrated from the source logical device to the target logical device, then the data is shredded in the source logical device, and finally the source logical device is designated as available for further operations.

In a further embodiment, a group of addressable storage locations, for example a set of logical devices (LDEVs) in a storage system, is reserved for use in storage operations, and other accesses to that group are precluded. These addressable storage locations typically may comprise a physical volume, a logical volume, a block, a sector, or any other addressable range of locations where data is stored. An addressable location of one member of the group not being used is then selected and whatever data is located at that addressable location is shredded by being overwritten with a predetermined pattern of data. Finally, the selected addressable location is designated as available for any operations, including operations within the group.

### BRIEF DESCRIPTION OF THE DRAWINGS

FIG. 1 is a block diagram of a storage system.

FIG. 2 is a logic diagram of the software components of the system in FIG. 1.

FIG. 3 is an LDEV configuration table.

FIG. 4 is an LU-LDEV mapping table.

FIG. 5a is a flow chart of a first method for migrating data.

FIG. 5b is a flow chart of a second method for migrating data.

FIGS. 6a and 6b are diagrams illustrating data migration.

FIG. 7 is a table of pooled LDEVs.

FIG. 8 is a diagram representing a GUI for data migration.

FIG. 9 is a flow chart of a migration scheduler.

FIG. 10 is a flow chart of another method for migrating data.

FIG. 11 is a flow chart of a method of shredding data.

FIG. 12 is a table of pooled LDEVs in another embodiment.

FIG. 13 is a diagram illustrating another method of migration.

FIG. 14 is a diagram representing another GUI for data migration.

FIG. 15 is a flow chart illustrating shredding data for released LDEVs.

FIG. 16 is a diagram representing another GUI for releasing reserved LDEVs.

FIG. 17 is a block diagram of another storage system.

FIG. 18 is logic diagram of the software components of FIG. 17.

FIG. 19 is a table for mapping external storage to a local system.

FIG. 20 is a mapping table for external storage.

FIG. 21 is a diagram showing a parity group extending across two logical units.

### DETAILED DESCRIPTION OF THE INVENTION

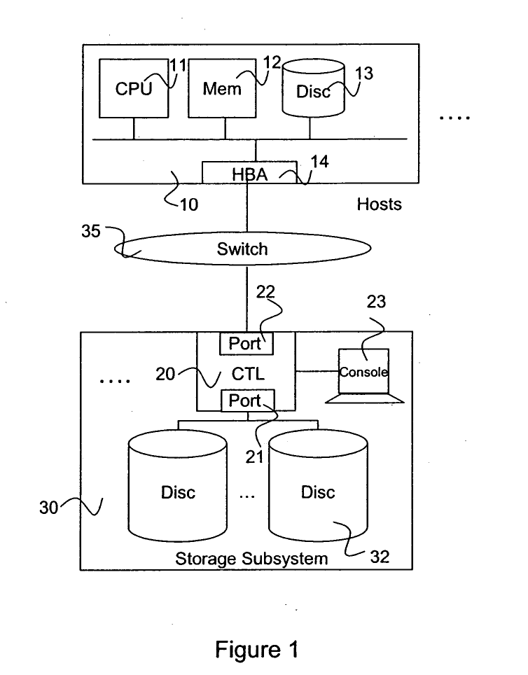

FIG. 1 is a block diagram illustrating a typical implementation of a storage system, with components and interconnections. In the illustrated implementation, a host 10 includes a central processing unit 11, memory 12, and an internal storage 13, typically a hard disk drive connected to each other with an internal bus. A host bus adaptor 14 is used to couple the host to a Fibre Channel or Ethernet switch 35. Also coupled to switch 35 is a storage subsystem 30. Generally, in systems such as depicted in FIG. 1, there will be multiple hosts and multiple storage systems, however, for purposes of explanation only a single host and single storage system are discussed here.

Storage subsystem 30 typically includes a port 22 coupled to switch 35, a controller 20, and a port 21. Port 21 is coupled to a bus, which is in turn connected to multiple disk drives or other storage media 32. The entire system is configured, and can be managed by, a console 23 coupled to the controller 20. The console may be located outside the storage subsystem to enable remote management via LAN or other communications technology (not shown).

Typically, data is stored on the hard disk drives 32 using small computer system interface commands, for example SCSI-2, 3, or iSCSI. The controller 20 preferably implements a redundant array of independent disk (RAID) technology to provide high reliability using these disk redundancy techniques. The controller 20 typically includes processors, a memory, a network interface card suitable for being coupled to via the Ethernet or Fibre Channel. The controller also preferably includes a non-volatile random access memory to store data in a data cache and protect it from power failures and the like. This enhances reliability of the data storage operations. The controller port 21 is coupled to several disks 32. Each port is typically assigned a World Wide Name (WWN) to specify target IDs for use in SCSI commands or logical unit numbers in Fibre Channel based systems.

The management console 23 is connected to the storage subsystem internally and is accessible using a general internet-based personal computer or workstation, enabling management of the storage subsystem. This management may involve typical RAID operations, such as creating parity groups, creating volumes, changing configurations, mapping of volumes to logical units (LU), etc. In general, the console provides an administrative interface to the storage system. In this explanation, although the console is shown as directly connected to storage subsystem, the console may be connected from outside of storage subsystem, for example, via an Ethernet based Local Area Network to enable remote management of the storage system.

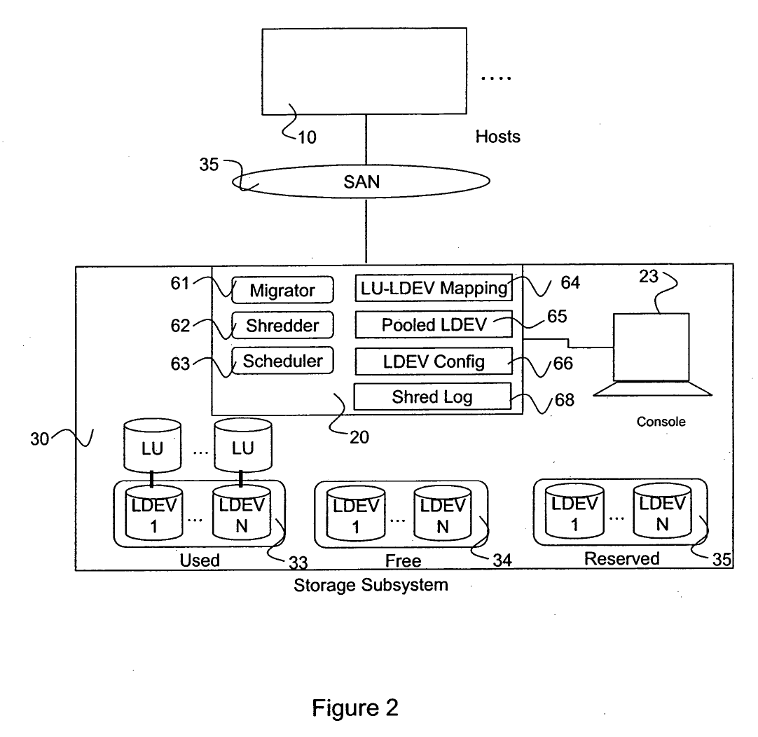

FIG. 2 is a diagram illustrating the software components and interconnections among them for a typical storage subsystem such as depicted in the lower portion of FIG. 1. The storage area network functionality is implemented by logical connections between the host 10 and the storage subsystems 30 using switches such as described above. The functionality is referred to as provision of a storage area network (SAN).

Within the storage subsystem 30 basic storage capabilities are provided, preferably by being enabled in microcode which software is provided via compact disk, floppy disk, an online installation executed on the controller, or other well known means. Typically this will be configured upon installation of the storage subsystem. This microcode usually includes a module for creation of parity groups. The parity groups consist of groups from the disks which are configured using the desired level of RAID technology, e.g. RAID 0/1/2/3/4/5/6. (RAID 6 is dual parity technology.) The resulting created parity group is listed in a configuration table maintained in the storage subsystem, as will be discussed below.

Preferably, the software in the storage subsystem 30 includes controller microcode for providing migrating 61, shredding 62, and scheduling 63 functionality. It also maintains a mapping table 64 for relating the logical units to the logical device numbers. It also includes information about pooled logical devices 65, configuration data for those devices 66, and preferably, a shredding log 68. These components are discussed below.

Across the lower portion of FIG. 2, the logical devices (LDEV) that are created from a portion of a parity group defined by LDEV configuration table 66 as a logical addressable location are represented as cylinders 33, 34, and 35. As shown, the logical units (LU) are assigned various logical devices for implementation. The assignment illustrated is arbitrary; it is possible for one logical unit to be configured as many logical devices, or for a single logical device to enable multiple logical units. The units and devices in use in the storage subsystem depicted are shown and designated with Teference numeral 33 in FIG. 2. To facilitate management operations, preferably each LDEV is unique in the storage subsystem. Devices that are reserved are designated by the numeral 35, while devices that are available are designated by reference numeral 34.

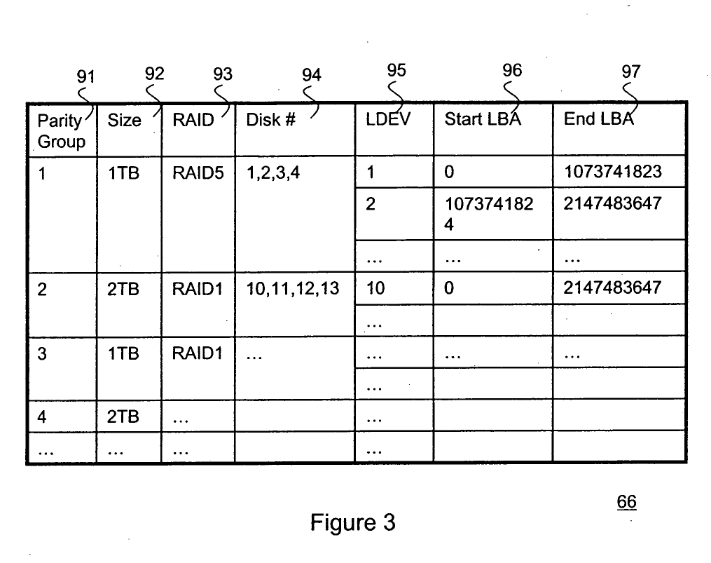

As mentioned in conjunction with FIG. 2, the system configures the storage devices in parity groups using RAID technology. As shown in FIG. 3, each parity group is set forth in a row of the figure. For example, parity group 1 has a size 92 of one terabyte and implements RAID 5 functionality 93. This parity group includes disks 1, 2, 3, and 4 which are configured by logical devices 95 as 1, 2, . . . . These devices have corresponding starting logical block addresses (LBA) starting at address 96 and ending at address 97. As evident from the table, the size 92 and RAID level 93 can be different from one parity group to the next. As described in FIG. 3, the mapping between a particular logical device and a parity group includes a starting logical block address (LBA) which is indicative of the LDEV starting and ending addresses within the parity group.

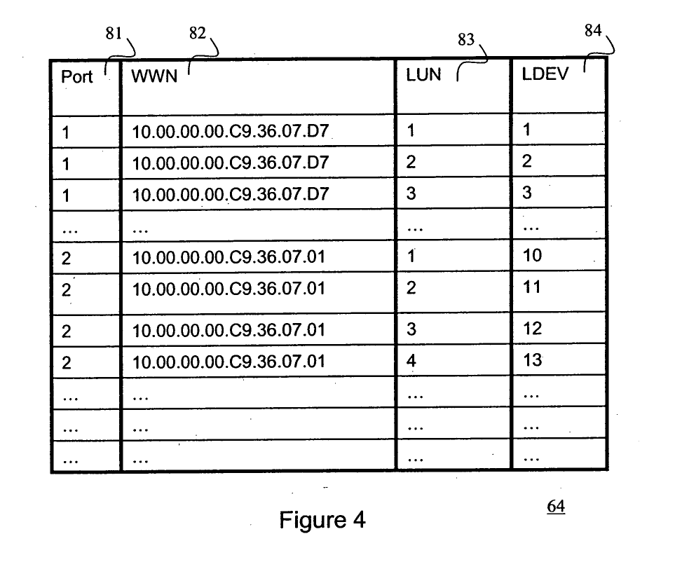

FIG. 4 is another table 64 which the controller uses to represent the logical units. This table defines the relationships among the ports 81, World Wide Name 82, logical unit number 83, and logical device number 84. The assignment of these characteristics to particular ports enables the controller to direct information appropriately within the storage system, thereby assuring it will be recorded to and retrieved from the addressed location. The table shown in FIG. 4 is also defined at initialization of the storage system, typically by the storage system administrator configuring the system when it is installed or configured.

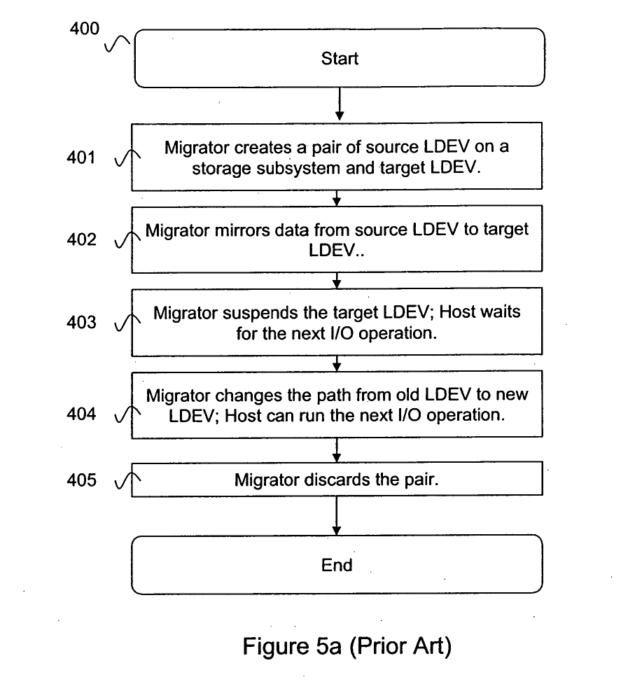

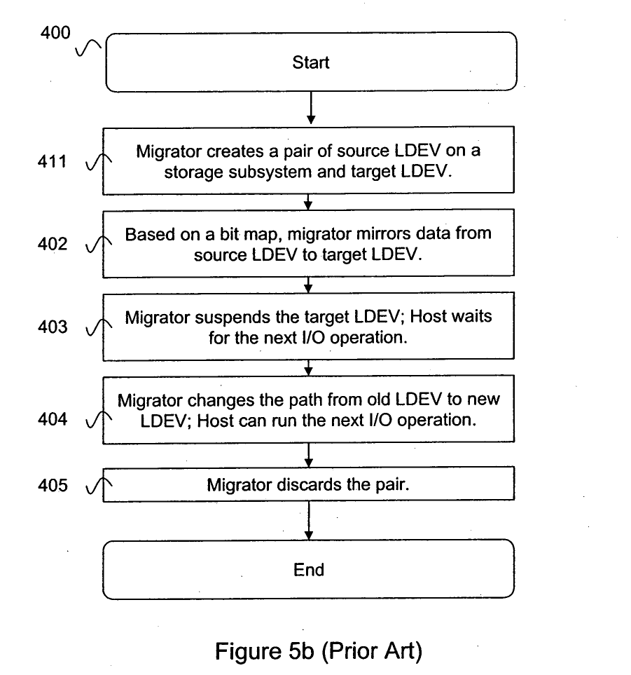

FIG. 5a is a flowchart illustrating the functionality of the migrator 61 shown in FIG. 2. The migrator 61 has the capability of migrating online data from a logical device on a storage subsystem to a logical device on the same storage subsystem, or to other storage subsystems. (The term “subsystem” is used herein to designate that the storage system is a portion of an overall system which includes the host.) FIG. 5a illustrates a first process for migrating data. This migration task is defined by scheduler 63 and is executed when scheduled, or manually as desired. Until migration begins, the host input-output channel continues to access the source logical device.

At step 401 the migrator creates a pair consisting of a source LDEV on a storage subsystem and a target LDEV, which is selected from a pool of available devices. At step 402 the migrator creates a synchronous status between the source LDEV and the target LDEV, and mirrors the source LDEV to the target LDEV. During the mirroring, the host updated write I/Os are also written on the target LDEV.

At step 403 the migrator suspends operations to and from the target LDEV. At this point the host will wait for the next I/O operation. (The storage subsystem is not yet aware of the new address to be used for data on the former source LDEV.)

Next, as shown in step 404, by making appropriate changes in the various tables in the storage subsystem, the migrator will change the path which is LU and WWN as seen by the host for host operations from the source LDEV to the target LDEV within storage subsystem. The next I/O operation from the host will thus access the target LDEV. Finally, in step 405 the migrator discards the pair, logically breaking the link between the source and the target.

FIG. 5b is a flowchart similar to FIG. 5a, except that in FIG. 5b the operations are performed based upon a bitmap 412. In such implementations, a bitmap is provided which tracks which portions of the source have been copied to the target. For example, assume that a block of data is represented by a 1 or a 0 in the bitmap. As these portions of data are copied from the source to the target, the corresponding bit on the bitmap is turned on. This can allow the host to continue accessing the storage during the migration, with the bitmap providing a guide for determining when writing data, whether the new data should be written to the source (for data that has not yet been migrated) or to the target (for data which has been migrated). A similar use of the bitmap is made for read operations. If the bit map is turned on, the controller reads data from the target device. If the bit map is turned off, it read data from the source device. These operations are discussed below.

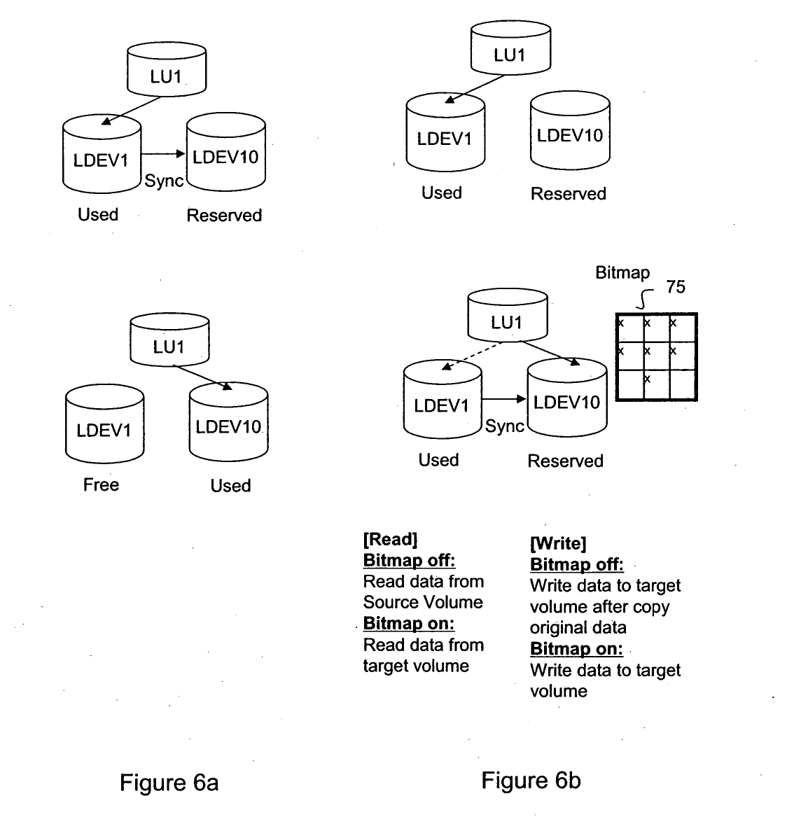

FIG. 6a is a diagram illustrating the flowchart of FIG. 5a. As shown in FIG. 6a, a logical unit LU1 is implemented by logical device LDEV1, used by LU1 for reading and writing operations (6a-1). When the data is to be migrated, LDEV 1 and a second disk LDEV 10 are synchronized (6a-2). This operation results in the data transferred to LDEV 10, which is shown in the lower portion of the figure (6a-3). From then on, LDEV 1 is designated as free, and made available for other storage controller operations while the system accesses LDEV 10.

FIG. 6b illustrates the data migration operation when a bitmap is employed. The operations begin and end in the same manner as those of FIG. 6a-1 and 6a-2, with LDEV 1 providing data for LU1. Instead of FIG. 6a-2, after the establishment of bitmap 75, future operations are controlled by the bitmap. The bits in the bitmap are set as the data is migrated from LDEV 1 to LDEV 10. Thus, for read operations when the appropriate bit of the bitmap is off, data is read from the source volume (LDEV 1). For read operations when the bitmap is on, read operations access data on the target volume LDEV 10. Write operations occur similarly. After data from the source volume has been copied to the target, writes are made to the target volume as designated by the bitmap being on. When the bitmap is off, data is copied to the target volume from the source volume.

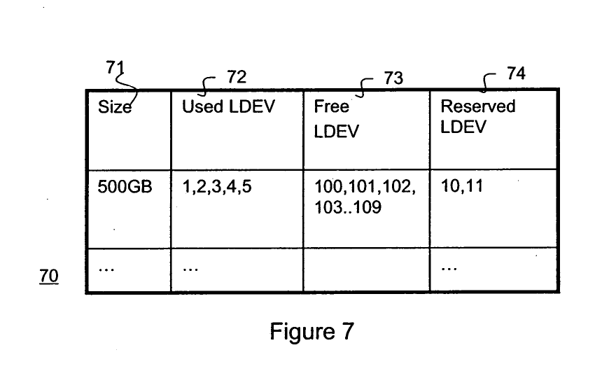

FIG. 7 is a table illustrating how the system tracks the status of various LDEVs. An exemplary embodiment is that 500 gigabytes of storage 71 are implemented by using five LDEVs 72 as shown. The list of free LDEVs is shown in column 73, and the list of reserved LDEVs is shown in column 74. As will be discussed below, preferably the free LDEVs have been shredded before being made available for further operations.

The system shown in FIG. 2 also includes a shredder 62. Shredder 62 controls shredding of data on the LDEVs which are to be made available for future use. The shredding operation is performed by overwriting data on the hard disk drive with a desired pattern. Table 1 below illustrates a variety of known shredding algorithms. Of course, other approaches or patterns may be used, all with the goal of rendering the data on the hard disk drive meaningless to anyone trying to access that data. When the system shreds data, the microcode indicates the write thought mode, meaning the storage subsystem does not cache data for the shredding algorithm data buffer, thus achieve the goal of the shredding. The Write command in the SCSI command set for the disc which has target LDEV's data has a bit to enable this operation using the ForceUnitAccess (FUA) bit set to exclude the buffer operation on each disc controller. In another approach, flush data for disc on buffer after write operation may be used. The commands are SYNCHRONIZE CACHE in SCSI and FLUSH CACHE in ATA/IDE.

TABLE 1
Typical Data Shredding Techniques

| Write Method | Description |
|---|---|
| 0 filling | Write all bytes with hexadecimal 00 |
| 1 filling | Write all bytes with hexadecimal FF |
| User pattern | Write all bytes with a user-defined pattern |
| NSA standard | After writing two random patterns, write all |
| | bytes with 00 |
| Prior NSA standard | Write all bytes with FF, then write a pattern |
| | of 00, FF, 00 . . . |
| DoD standard | Write all bytes with 00, then FF |
| NATO standard | Write the disk with a pattern: 0, FF, |
| | 0, FF, 0, FF . . . |

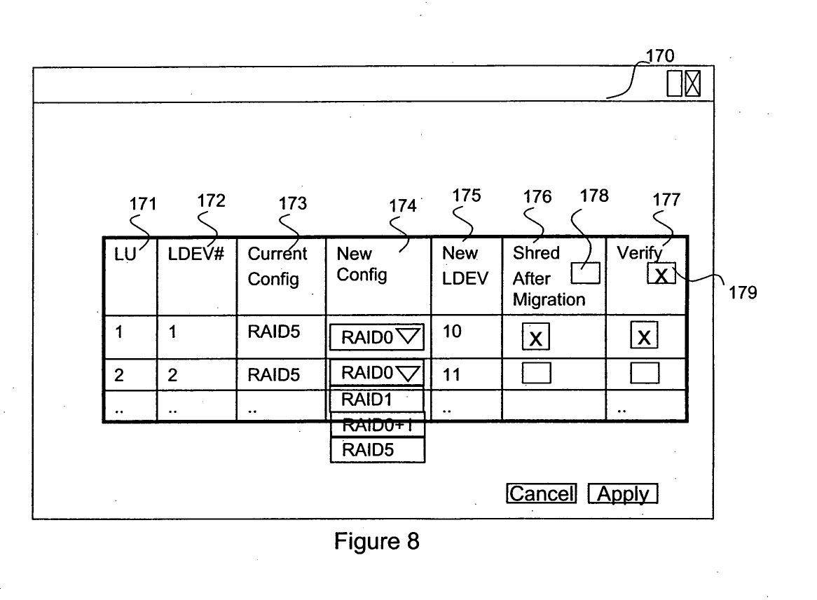

Next, the techniques for migrating data and shredding the data from the source drive after the data has been migrated are discussed. As an initial step an administrator uses information in a form such as FIG. 4 to define a relationship between a logical unit and a logical device. This assignment, as mentioned above, is performed using the console 23 shown in FIG. 1. Once the LDEV is assigned to a particular logical unit, that LDEV is considered “used” and is no longer available for other operations. To begin the migration, the administrator creates a job to migrate data from the source LDEV (designated as used in FIG. 4) to a target LDEV, selected from the free LDEVs in the storage subsystem using the console. A typical graphical user interface for performing this operation is shown in FIG. 8. As shown there, the GUI includes a list of logical units 171 and logical devices 172. This information was collected from the table shown in FIG. 4. The GUI also provides an indication of the current configuration (RAID 5 for LU1) and allows selection of a new configuration using a pull-down menu such as shown in column 174. The RAID configuration 173 is collected from configuration table 90 shown in FIG. 3. A new LDEV 175 is selectable by choice from the free LDEV list 73 shown in FIG. 6. The GUI also provides the user choice as to whether the data on the source drive is to be shredded after the migration occurs, as shown by column 176. A verify toggle 177 may be provided to require confirmation of the shredding decision. Indicators 178 and 179 enable selection of a uniform choice for columns 176 and 177, respectively. If the storage administrator wishes to have accessible the variety of shredding techniques shown in Table 1, or others, an additional GUI may be provided for selection of those techniques. This can take the form of an additional column in FIG. 8, or another button in FIG. 8 which allows movement to a second screen for selection of the particular techniques. Regarding the source and target location information, current 174 and new configuration 175, other types of information, for example, storage device type (Fibre Channel, Parallel ATA, Serial ATA, Serial Attached SCSI, etc.) and the capacity of LDEV to upgrade of size LDEV when the LDEV configuration table has a column for storage types or the migrator migrates data from a sized volume to another sized volume. In case of upgrading the capacity, after the migration, the LU returns a new size of disk to host when host requests volume size to the LU and administrator for the host may rewrite the size of volume on header of volume to understand the size of volume using OS vender provided tools like logical device manager in Windows and etc. manually.

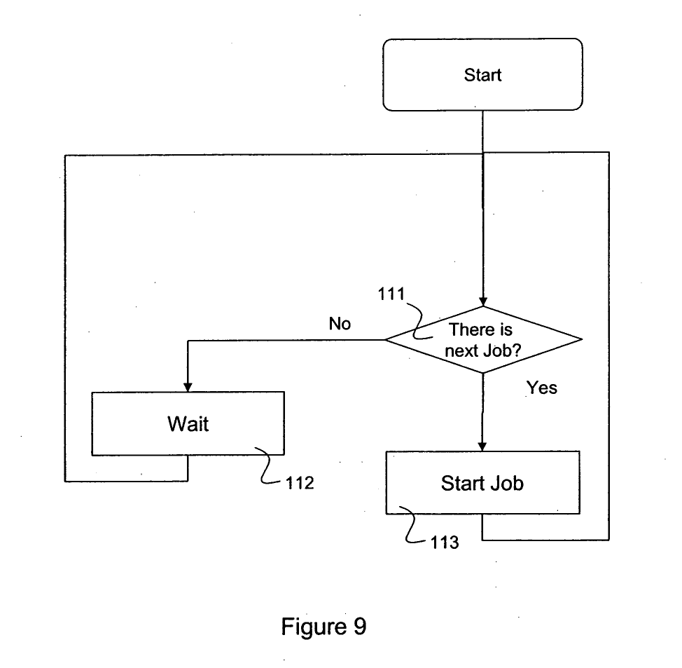

FIG. 9 is a flowchart illustrating typical procedure for scheduling the operations. This operation is similar to the cron job manager in UNIX. As shown in FIG. 9, after the procedure starts, if there is a migration/shredding job present, control shifts to step 113 and the job is performed. If not, the system waits at 112 for the next job to appear.

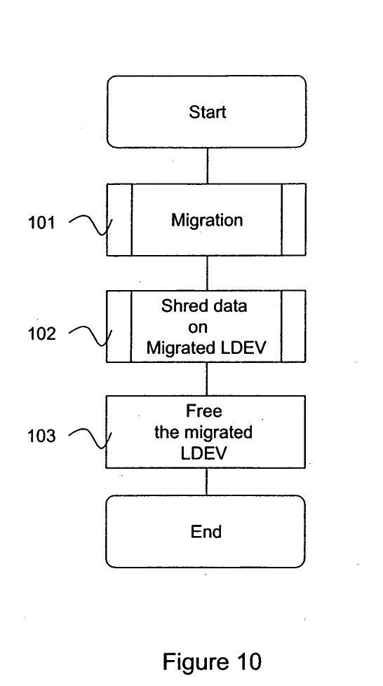

FIG. 10 is a flowchart illustrating the execution of the migration and shredding operations. As shown there, after the start of the procedure, a migration step 101 is performed. This operation was described earlier in conjunction with FIGS. 5a and 5b. After the migration is completed a shredding operations is performed as shown in step 102. The particular details of this shredding operation are discussed below. After step 102 is completed, step 103 is performed by which the LDEV from which the data has been migrated is designated as free, thereby making it available for further operations. The procedure then ends.

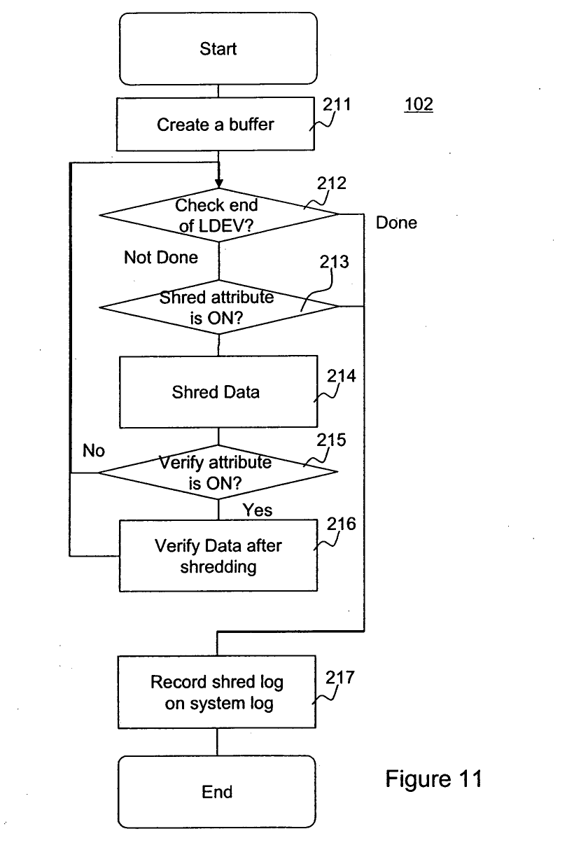

FIG. 11 is a flowchart illustrating the shredding operation 102 illustrated in block form in FIG. 10. In FIG. 11, an initial step 211 is that a buffer is prepared using a microcode operation. This buffer, for example, on the order of 8K bytes in a typical installation, provides storage for insertion of write data, e.g. the patterns shown in Table 1. It also includes storage for a pointer to designate the current position of the shredding operation.

At step 212 the current position of the shredding operation is checked to determine whether it has reached the end of the LDEV. If the current logical block address (LBA) plus the size of the buffer indicates that the LDEV has been reached, then control transfers to step 217 and the shredding operation is logged, as discussed below. On the other hand, if the end of the LDEV has not been reached, then transfer moves to step 213. If that flag is on, then control moves to step 214 for the shredding operation. If the flag is off, the shred is completed, and control moves to step 217 and the pointer is shifted to the next 8 KB.

In the shred data step 214, shred data in the buffer, based upon the administrator selected method, is written to the current position. The cache memory for the target LDEV is typically off during this operation. This means the write to shred became write through as discussed above. Next, at step 215, a check is made as to whether the verify attribute is on, in which case the data is verified by comparing between the data on the buffer and reading written data from disc after the shredding operation at step 216. If it is off, then control returns to step 212. After the completion of the entire LDEV, or whenever control has been switched to step 217, the shred log is updated. A typical shred log is shown in Table 2 below.

TABLE 2
A Typical Shred Log

| Date | Time | Operation |
|---|---|---|
| 2004/08/21 | 10:00:31 | Success - Shred LDEV 10 for Reserved LDEV |
| 2004/08/21 | 10:00:32 | Success - Shred and verify LDEV11 for |
| | | reserved LDEV |
| 2004/08/21 | 10:00:33 | Success - Shred and verify LDEV12 for |
| | | reserved LDEV |
| 2004/08/21 | 10:00:34 | Success - Shred - Fail Verify - LDEV13 for |
| | | reserved LDEV. Retry Needed |

Preferably the system administrator can require a read only operation for the shredding log to enable it to be retained as evidence of proof of document or data destruction.

As mentioned above, in a second implementation of the shredding techniques according to this invention, whenever a system administrator removes a particular LDEV from the reserved pool, data on that LDEV is shredded. The primary benefit of this method is that the shredding operation, which can consume considerable time for large hard disk drives, is minimized with respect to the alternative shredding embodiment. In this implementation, data is shredded on the disk drive only when that drive is released from a reserved state. This is made possible by the storage system precluding access to the LDEVs held in the reserved pool. In a typical operation, at a future time these reserve LDEVs would be overwritten with new data from various source LDEVs, for example, in ordinary mirroring or backup operations. Once those operations are concluded, however, the reserved LDEVs will have original data when they are released to the free state, and at that time, before the release the data on those LDEVs will be shredded.

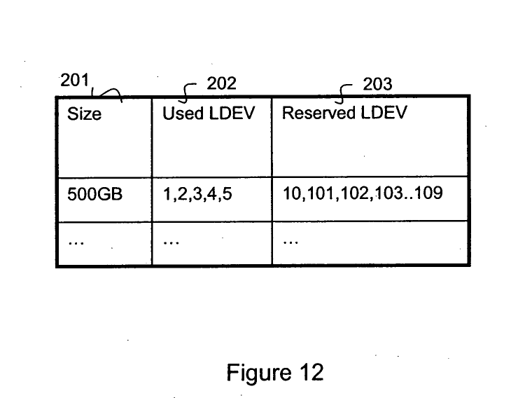

In this implementation, the storage system preferably has a configuration such as shown in FIG. 1. The logical configuration, however, is different from that in the preceding embodiment. In this embodiment, only two states are needed—used and reserved. The used LDEV means that LDEV is being used by the host. A reserved LDEV is a candidate LDEV for future migration (or other operations). Typically, the administrator will define a stock of reserved LDEVs for migration target before beginning the migration operations. FIG. 12 is a table illustrating a typical implementation. Each size 201 is associated with a particular set of used LDEVs 202 and reserved LDEVs 203.

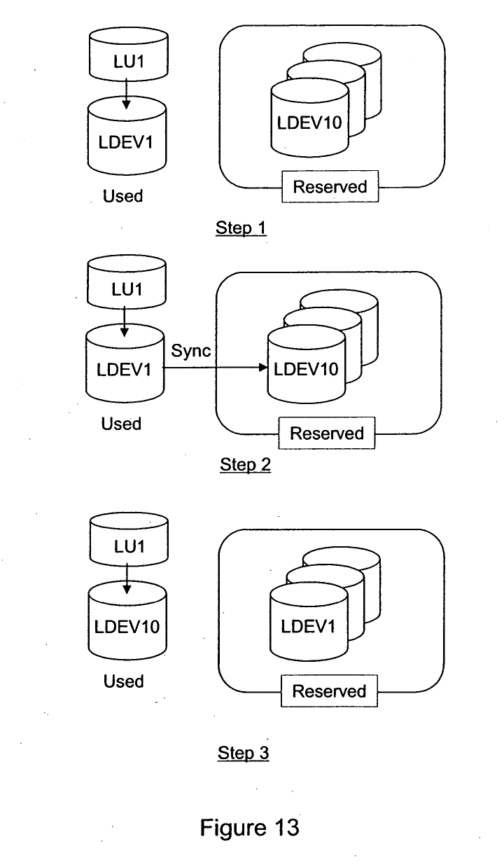

FIG. 13 is a diagram illustrating the pooled LDEVs as represented by the table shown in FIG. 12. In a first step, the administrator creates an LU-LDEV mapping to represent the LDEV to the host, and also defines a stock of reserved LDEVs to serve as migration targets. The administrator then starts a migration, for example using the techniques described above. In this migration operation the used LDEV 1 is synchronized with the reserved LDEV, LDEV 10. Following the operation LDEV 1 is returned to the reserved pool.

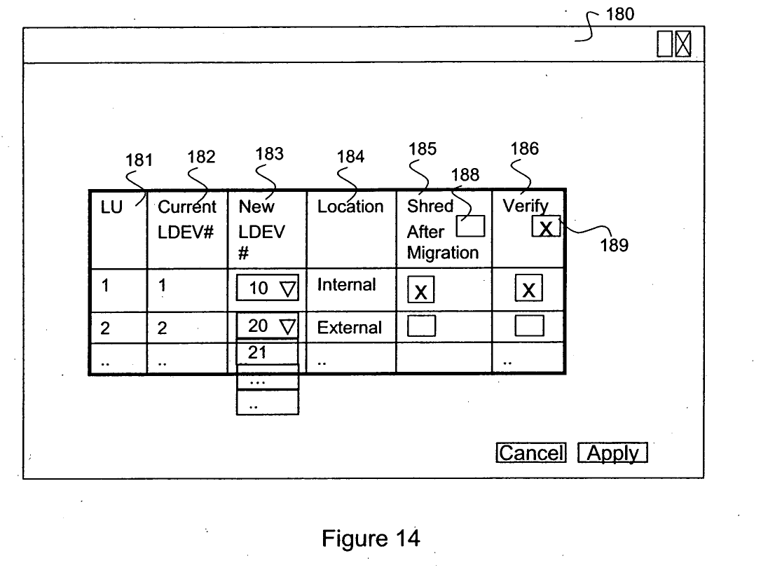

The migration operations in this circumstance proceed as follows. The administrator will initially create an LU-LDEV mapping, thereby creating the “used LDEV” state. During this operation several reserved LDEVs in the pool will be assigned, as shown in FIG. 12. Then, to start the migration, the administrator creates a job to migrate data from the source LDEV, again using a GUI on the console. FIG. 14 illustrates a typical GUI.

The GUI of FIG. 14 consists of columns designating the logical unit 181 and the current LDEV 182. This information is collected from the mapping table shown in FIG. 4. The user selectable new target LDEV 183 can be chosen by an appropriate GUI interface, such as a pull-down menu as illustrated. The LDEVs available in column 183 are those in the reserved pool 203 (FIG. 12). The RAID configuration may also be displayed, for example as discussed with respect to FIG. 8 above. In the same manner as with respect to FIG. 8, the user or system administrator, may choose to shred the data after the migration occurs and to verify that shredding operation, as indicated by selection of appropriate indicia in columns 185 and 186. In the same manner as discussed above, once the job is created, it is queued on the scheduler 63 (FIG. 2).

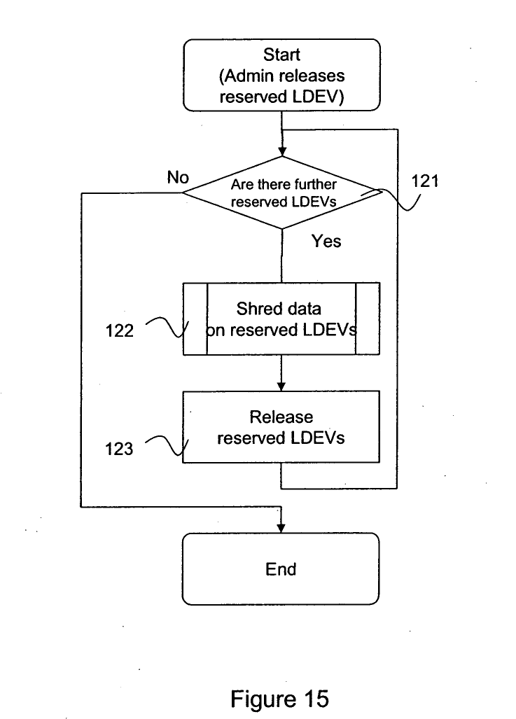

Because the reserved LDEVs are overwritten by source LDEVs, during each migration, from the user perspective if the reserved LDEVs are released, the data on them should be shredded. This process is described in conjunction with FIG. 15. FIG. 15 is a flowchart of the overall shredding operation performed in conjunction with implementations such as depicted in FIG. 13. As shown in FIG. 15, after a start in which the administrator releases a reserved LDEV, an initial check is made at step 121 to determine if there are further reserved LDEVs. If there are not, the process ends. If there are, then the flow of the process moves to step 122 in which the data is shredded on the reserved LDEVs. This process is carried out using the same techniques as described in conjunction with FIG. 11 above. After the shredding operation, the reserved LDEVs are released as shown at step 123. The process flow then returns to step 121 to determine whether additional LDEVs require shredding.

If the storage administrator wants to shred data reserved in the LDEVs on the disc physically, instead of from the user perspective, the storage subsystem has an option to create a physical shred task using the procedure in FIG. 11. This option for reserved LDEVs is set by the console. When the option is set, the storage subsystem creates a task of shredding data after the migration. The task is executed based on the scheduler and then the storage subsystem shows “n” reserved LDEV candidates as a new target LDEV in graphical interface 183

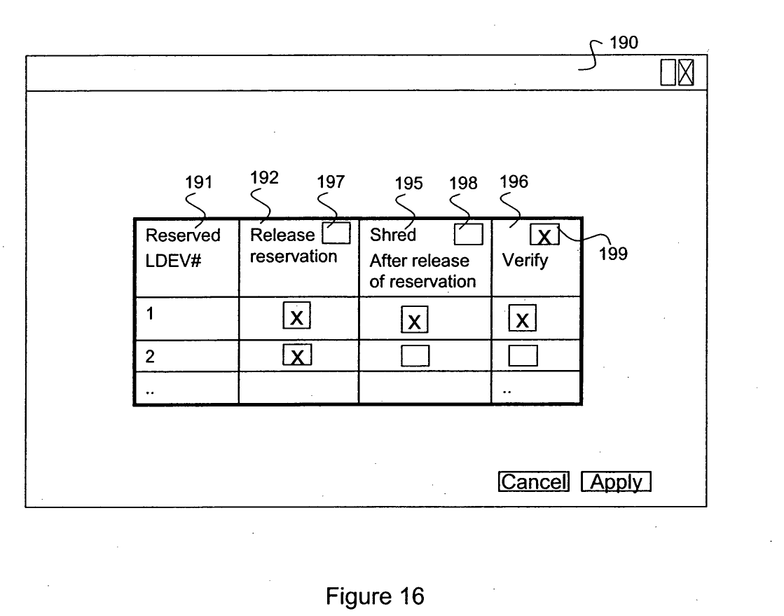

FIG. 16 is a diagram illustrating the graphical user interface for the step in which the administrator releases the reserved LDEVs. This GUI consists of the current reserved LDEV number 191, a switch 192 to indicate release of the reserved LDEV, a shred switch 195 to indicate whether data is to be shredded after the release operation, and a verify switch 196 to indicate whether verification of the shredding is to be performed. Note that the verify operation 196 is not enabled if the shredding operation 195 is not selected. As with earlier described GUIs, the administrator may use switches 197, 198, and 199 to turn on the entire column. In addition, as also described above, additional features may be added to the GUI to enable selection of a particular shredding method, either in a column manner as depicted for the other switches, or by a button or other interface to bring up a further GUI.

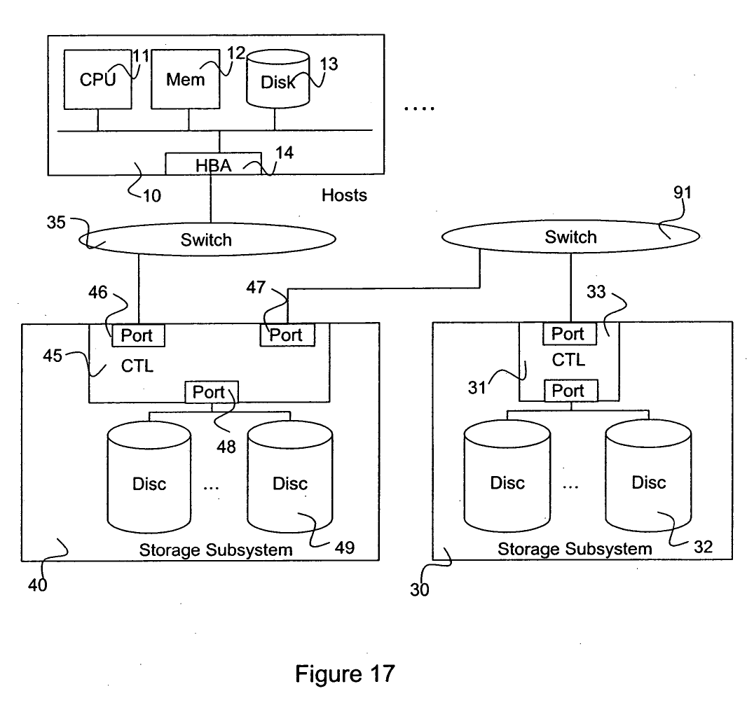

FIG. 17 is a block diagram illustrating an alternative embodiment in which two storage subsystems are employed. While subsystem 40 is coupled via switch 35 to the host 10, a further storage system 30 is coupled via switch 91 to a port 47 in storage subsystem 40. In this implementation, the external storage subsystem 30 can employ the migration and shredding methods described above while at the same time providing an external storage resource for host 10. The primary difference between this implementation and the implementation described in FIG. 1 is that the controller 45 includes a second port 47 for communicating with one or more external storage systems, for example via switch 91. In effect, storage subsystem 40 is using subsystem 30 to provide logical devices to supplement those in subsystem 40.

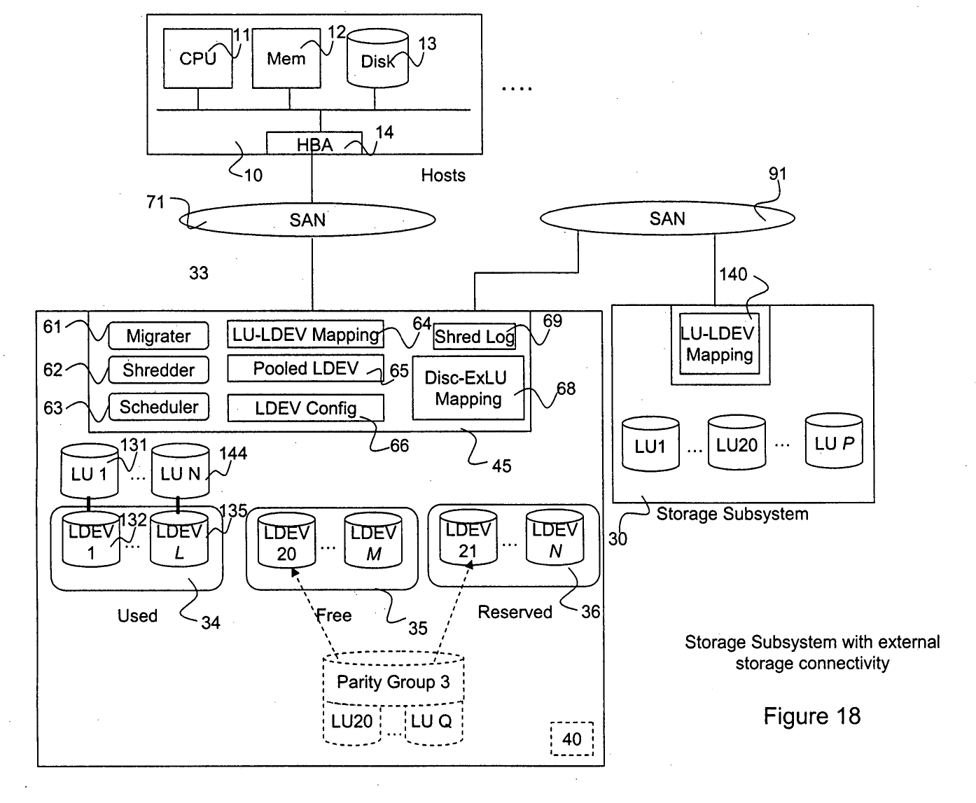

FIG. 18 is a logical diagram of the system illustrated in FIG. 17. FIG. 18 is similar to FIG. 2 except that it includes the additional storage subsystem 30, and also includes information 68 which maps the external logical units from subsystem 30 to subsystem 40 and a process of write though mode based on the above. Generally, the system administrator of system 40 will control the administration of system 30.

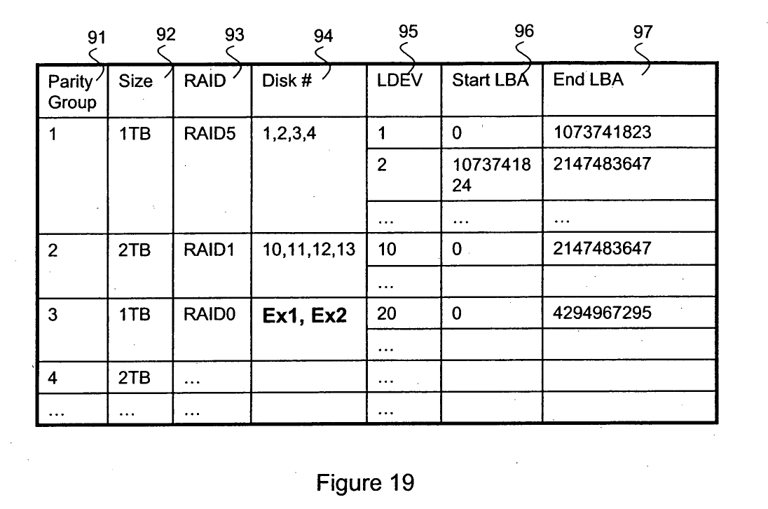

A typical implementation of the mapping table 68 is shown in FIG. 19. The mapping table includes the parity groups 91, logical unit size 92, RAID technology employed 93, etc. Importantly, however, the mapping table also maps the external drives into the storage system 40. For example, parity group 3 is shown as including external LUs 1 and 2 in column 94. The mapping table is similar to the mapping table described with respect to FIG. 3, and like that table, is set up by the system administrator. The write through mode is t6 disable the data cache for the LDEV and the disc buffer residing the LDEV using the SCSI write command, ATA/IDE, or other means to control the disc from the storage subsystem 40 correctly.

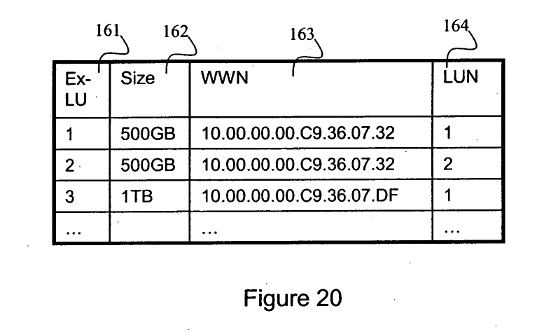

FIG. 20 is a table which illustrates the relationship among the external logical units 161, their size 162, their World Wide Name 163, and the logical unit number 164. This table corresponds to that described with respect to FIG. 4, and provides the same functionality in this implementation. To implement the migration and shred techniques described above, the administrator must first make a mapping of the external LUs using the console as described above. This mapping is stored in the table depicted in FIG. 20 and the external LU is assigned the number identifier as shown in FIG. 19. The administrator then creates an LDEV and, if necessary, defines the logical unit path on the table in FIG. 19 using the console. The migration and shredding can then be performed as described above. In these implementations the source and target LDEVs can be chosen without regard to their location in the local storage system 40 or the remote storage system 30 (see FIG. 18).

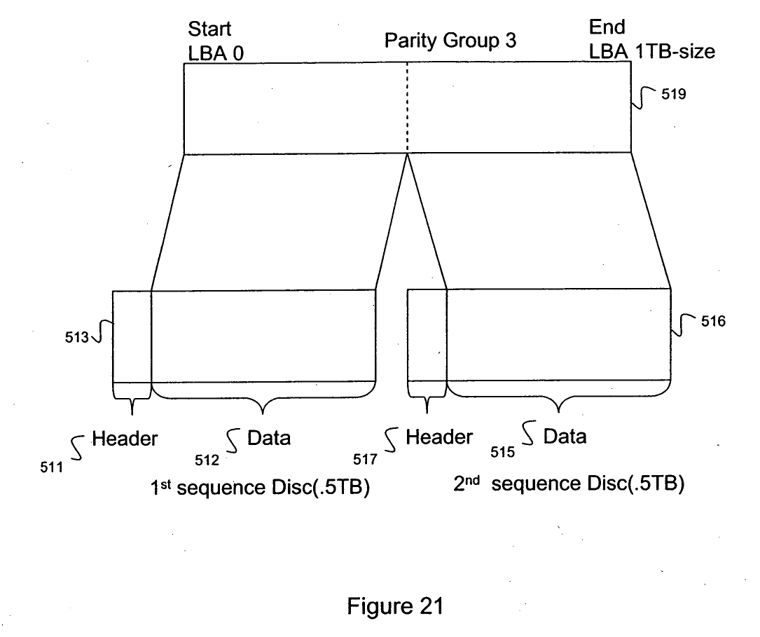

The implementation described in FIG. 21 uses an external disk number to indicate the relationship to the logical units on the external storage system. As discussed above, the storage subsystem can create parity groups using the external logical units. In FIG. 20, external logical unit 2 is shown as providing a 500 gigabyte logical unit. The parity groups themselves may comprise disks from different storage subsystems, as suggested by FIG. 19, and as discussed next.

The storage system can create a parity unit from the external logical units, coupled with other external logical units or internal logical units. This is illustrated in FIG. 21. In FIG. 21, 500 gigabyte logical units 512 and 515 are combined to create a single parity group 3. After creating the mapping table for the external logical unit, the volume manager makes a single parity group which concatenates these two 500 gigabyte logical units, each of which has previously been assigned an identifier. Each logical unit includes header information 511, 517 and a logical block address from the address base. The size of the header may vary depending on the information it is to contain. In the depicted implementation, the header information is 512 bytes, which is used for, defining the data space, the parity group, the port and logical unit number on a port, the number of logical disks, the RAID configuration, etc. The data address space in the first sequence from one of the logical units extends from after the header to the size which is written in the header. Similarly the data address for the second sequence extends from after the header to the size written in the header. For example, if the size of the parity group for the logical unit is 1 terabyte minus the size of the headers, the address mapping between LDEV and the physical address space on the storage subsystems is as follows. LBA 0 in parity group 519 begins after the header size 513 in the first sequence. The data address space 512 extends from after header 511 to the size which is written in the header 511. The next address base in the second sequence extends from after the header 517 to the size written in the header 517 of the second sequence.

The preceding has been a description of the preferred embodiments of this invention. It should be appreciated that variations may be made within the particular implementations discussed without departing from the scope of the invention. The scope of the invention is defined by the appended claims.

1. In a storage system for storing data at a plurality of addressable locations therein, a method of migrating data from a first addressable location to a second addressable location, the method comprising:
storing data at the first location;
copying the data to the second location without erasing it from the first location;
shredding the data at the first location by overwriting it with a predetermined pattern of data; and
designating to the storage system that the first location is now available for future data actions.

2. A method as in claim 1 wherein the predetermined pattern is one of overwriting the data with ones, with zeros, with a user defined pattern, and with an NSA, NATO, or DOD pattern.

3. A method as in claim 1 wherein the step of copying the data comprises:
establishing a pair relationship between a source of data corresponding to the first location and a target of the data at the second location;
mirroring data from the source to the target;
suspending writing or reading of data to the source pending a further request relating to the data from a host coupled to the storage system;
defining a path to the data at the target location; and
discarding the pair relationship to cause a host to access the data at the second location.

4. A method as in claim 1 wherein the addressable storage locations comprise a logical portion of the storage system.

5. A method as in claim 4 wherein the logical portions comprise a parity group of hard disk drives.

6. In a storage system for storing data at a plurality of addressable locations therein, a method of protecting data at an addressable location from being accessed while enabling storage system operations, the method comprising:
designating a group of at least one of the addressable storage locations as reserved for use in operations and precluding access to that group;
selecting one addressable location of the group;
shredding whatever data is on that addressable location by overwriting it with a predetermined pattern of data; and
releasing the selected one addressable location of the group and designating it to the storage system as available.

7. A method as in claim 6 further comprising repeating the steps of designating, selecting, shredding and releasing until all of the addressable locations are available for future operations.

8. A method as in claim 6 wherein the predetermined pattern is one of overwriting the data with ones, with zeros, with a user defined pattern, and with an NSA, NATO, or DOD pattern.

9. A method as in claim 6 wherein after the step of releasing, steps are performed comprising:
establishing a pair relationship between a source of data corresponding to a first location not in the group and a target of the data at the second location which is in the group;
mirroring data from the source to the target;
defining a path to the data at the target location; and
discarding the pair relationship to cause a host to access the data at the second location.

10. A storage system for shredding data stored at an first address after that data has been migrated to a second address comprising:
a controller coupled to receive data from an external source and to provide data to the external source;
a plurality of addressable storage locations coupled to the controller for reading and writing data in response to requests from the controller;
wherein the controller includes:
a migrating function for copying data from a first addressable location to a second addressable location;
a shredding function for overwriting data stored at the first location after it has been copied to the second location; and
a protection function for preventing access to the first location until after the data stored at the first location has been overwritten.

11. A storage system as in claim 10 wherein all of the addressable locations comprise locations in an array of hard disk drives in a parity group in a single storage subsystem.

12. A storage system as in claim 11 wherein the addressable storage locations comprise a first group of reserved storage locations and a second group of unreserved storage locations, and wherein a selected storage location remains in the first group until after data stored thereon has been overwritten, and then the selected storage location is released to the second group.

13. A storage system as in claim 12 wherein the first group includes storage locations that are not being used by the controller.

14. A storage system as in claim 10 wherein the controller maintains a set of tables which relate the addressable storage locations to logical storage units and to physical devices used to store the data.

15. A storage system as in claim 10 wherein the migrating function and the shredding function are selectable by a system administrator using a graphical user interface.

16. A storage system as in claim 15 wherein the shredding function can be verified afterward by a selection of the system administrator through the graphical user interface.

17. A storage system as in claim 10 wherein:
the controller is disposed in a first storage subsystem; and
the plurality of addressable storage locations coupled to the controller for reading and writing data in response to requests from the controller are disposed in a second storage subsystem; and
the first storage subsystem is coupled to the and second storage subsystem using a communications link.

18. A storage system as in claim 17 wherein the plurality of addressable storage locations coupled to the controller for reading and writing data in response to requests from the controller include addressable storage locations in each of the first storage subsystem and the second storage subsystem.

19. A storage system as in claim 10 wherein the controller further includes a log function for recording verification of shredding of data.
